(19) United States
(12) Patent Application Publication
(10) Pub. No.: US 2022/0118293 A1
(43) Pub. Date: Apr. 21, 2022

(54) FACE MASK

(71) Applicant: Shu-Te TSAO, West Covina, CA (US)

(72) Inventor: Shu-Te TSAO, West Covina, CA (US)

(21) Appl. No.: 17/074,666

(22) Filed: Oct. 20, 2020

(51) Int. Cl. A62B 23/02; A41D 13/11

(52) U.S. Cl. CPC A62B 23/02; A41D 13/1138

(57) ABSTRACT

A face mask includes a body, a first airflow member, and a second airflow member. The body is made of a see-through material and includes a first opening and a second opening. The first airflow member is coupled to the first opening. A filter is detachably mounted to the first airflow member and is aligned with the first opening. The second airflow member is coupled to the second opening. The second airflow member includes a chamber, at least one air inlet and at least one air outlet. The at least one air inlet intercommunicates with the outside. The at least one air outlet intercommunicates with an interior of the body and is misaligned from the at least one air inlet.

### BACKGROUND OF THE INVENTION

### 1. Field of the Invention

The present invention relates to a face mask and, more particularly, to a face mask permitting covered portions of a user to be seen.

### 2. Description of the Related Art

Conventional face masks are generally made of non-transparent materials, such as cloth or nonwoven fabric. A typical disposable medical mask is comprised of a three-layer structure including an outer layer of water-repellent nonwoven fabric, a middle layer of melt-blown nonwoven fabric, and an inner layer of skin-friendly nonwoven fabric. When a user is wearing a conventional face mask, the conventional face mask covers the nose, mouth, cheeks, and chin of the user. Since the nonwoven fabric is non-transparent, other people cannot clearly see the covered portions of the user from the outside. In a situation requiring facial recognition, such as identifying whether the identity of the user matches with ID or unlocking an electronic product through a facial recognition system, the user has to remove the face mask, such that the user cannot be protected in a case that requires wearing face masks. Furthermore, a wearer cannot transmit his or her facial expression or lip language, such that the hearing impaired that learns language from the shape of the mouth or reads lip cannot accurately learn or effectively communicate.

In view of the above disadvantages, manufacturers produced face masks with see-through polymers, such as transparent plastic. However, the material characteristics and the airtightness demand result in a poor effect in transmission of sound waves. As a result, the sound volume of the wearer transmitted to the outside of the face mask significantly drops, failing to provide effective communication.

Furthermore, a face mask made of a see-through polymer has poor permeability to air. Thus, when the wearer breathes, talks, coughs, sneezes, or yawns, the hot air and water vapor breathed out by the wearer cause increase in the humidity, temperature, and carbon dioxide concentration. As a result, the wearer wearing the face mask will feel uncomfortable due to mugginess.

In light of this, it is necessary to improve the conventional face mask made of see-through polymers, such as transparent plastic.

### SUMMARY OF THE INVENTION

To solve the above disadvantages, it is an objective of the present invention to provide a face mask made of a see-through material, permitting other people to clearly see the facial expression and covered portions of the wearer from the outside.

It is another objective of the present invention to provide a face mask that would not adversely affect the sound transmission effect, permitting the wearer to smoothly communicate with other people.

It is a further objective of the present invention to provide a face mask that can reduce the mugginess of the wearer to thereby improve the wearing comfort.

It is still another objective of the present invention to provide a face mask that can change the air tightness and the protection level according to the user needs.

It is yet another objective of the present invention to provide a face mask that can be repeatedly used to reduce the economic burden to the user.

When the terms “front”, “rear”, “left”, “right”, “up”, “down”, “top”, “bottom”, “inner”, “outer”, “side”, and similar terms are used herein, it should be understood that these terms have reference only to the structure shown in the drawings as it would appear to a person viewing the drawings and are utilized only to facilitate describing the invention, rather than restricting the invention.

As used herein, the term “a” or “an” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

As used herein, the term “coupling”, “engagement”, “assembly”, or similar terms is used to include separation of connected members without destroying the members after connection or inseparable connection of the members after connection. A person having ordinary skill in the art would be able to select according to desired demands in the material or assembly of the members to be connected.

A face mask according to the present invention includes a body, a first airflow member, and a second airflow member. The body is made of a see-through material and includes a first opening and a second opening. The first airflow member is coupled to the first opening. A filter is detachably mounted to the first airflow member and is aligned with the first opening. The second airflow member is coupled to the second opening. The second airflow member includes a chamber, at least one air inlet and at least one air outlet. The at least one air inlet intercommunicates with the outside. The at least one air outlet intercommunicates with an interior of the body and is misaligned from the at least one air inlet.

Thus, the face mask according to the present invention has a see-through body, such that most portions of the face of the user can be clearly seen from the outside. This allows the user wearing the face mask can still use the facial unlocking function of an electronic product, permit identity confirmation by the face, transmit facial expressions, or permit other people to read his or her lip language without removing the face mask. Furthermore, by maintaining a predetermined spacing between the body of the body and the nose and mouth of the user and by providing the filter and at least one opening, excellent ventilation can be maintained to reduce mugginess while wearing the face mask, thereby increasing use comfort. Furthermore, the adverse influence on transmission of sound can be reduced, such that the user can talk normally without increasing the volume. Furthermore, the second airflow member forms a passage preventing rectilinear flow of fluids. This improves air ventilation, avoids ambient droplets from entering the mask, and avoids droplets in the face mask from moving to the outside, increasing the protection level. Furthermore, by replacing the filters, the face mask can maintain an excellent filtering effect and can be adjusted according to user needs of different levels. Furthermore, the face mask can be repeatedly used to reduce the economic burden to the user.

In an example, the first airflow member includes two layers defining a gas passage therebeween. The first airflow member includes at least one first air hole therein. The at least one first air hole intercommunicates with the gas passage. The gas passage has an outlet at an intersection of the gas passage and the outside. The filter covers the at least one first air hole. Thus, the gas flowing through the gas passage move in a non-rectilinear path, effectively stopping droplets.

In an example, the first airflow member includes a separation plate having at least one second air hole, and the filter is located between the at least one first air hole and the at least one second air hole. Thus, the separation plate can assist in positioning of the filter, securing the filter and increasing convenience in replacement of the filter.

In an example, the at least one air first hole is misaligned from the at least one second air hole. Thus, the period of time of the air passing through the filter can be prolonged to improve the filtering effect.

In an example, the separation plate and the first airflow member are coupled by at least one coupling block and at least one coupling groove, permitting detachable coupling between the separation plate and the first airflow member. Thus, the separation plate and the filter can be easily detached from the first airflow member, increasing convenience in replacement of the filter.

In an example, the outlet of the gas passage faces downwardly. Thus, the air breathed out by the user can flow outwards from the lower side of the face mask. The hot air is prevented from moving upwards to avoid fogging of the outer surface of the body, thereby maintaining the see-through effect.

In an example, the chamber is defined between a covering plate and a lid of the second airflow chamber, and the at least one air outlet is formed in the covering plate. Thus, the gas entered via the at least one air inlet can move in a non-rectilinear path to the at least one air outlet.

In an example, the chamber receives another filter. Thus, the air entered via the at least one air inlet is filtered by the filter and then enters the body via the at least one air outlet, improving the filtering effect.

In an example, the body includes an anti-fog layer disposed on an inner surface of the body. Thus, the hot air breathed out by the user will not cause fogging of the inner surface of the body, maintaining the see-through effect.

In an example, the body includes an annular ring disposed on an outer periphery of the body. Thus, better airtightness can be provided between the body and the face of the user while providing wearing comfort for the user.

### BRIEF DESCRIPTION OF THE DRAWINGS

The present invention will become clearer in light of the following detailed description of illustrative embodiments of this invention described in connection with the drawings.

FIG. 1 is an exploded, perspective view of a face mask of an embodiment according to the present invention.

FIG. 2 is a diagrammatic view illustrating an outer side of the face mask of FIG. 1 after assembly.

FIG. 3 is a diagrammatic view illustrating an inner side of the face mask of FIG. 1 after assembly.

FIG. 4 is a cross sectional view taken along section line 4-4 of FIG. 2.

FIG. 5 is a cross sectional view taken along section line 5-5 of FIG. 2.

FIG. 6 is a cross sectional view illustrating the face mask of FIG. 5 provided with a filtering plate.

FIG. 7 is a diagrammatic view illustrating use of the face mask according to the present invention.

### DETAILED DESCRIPTION OF THE INVENTION

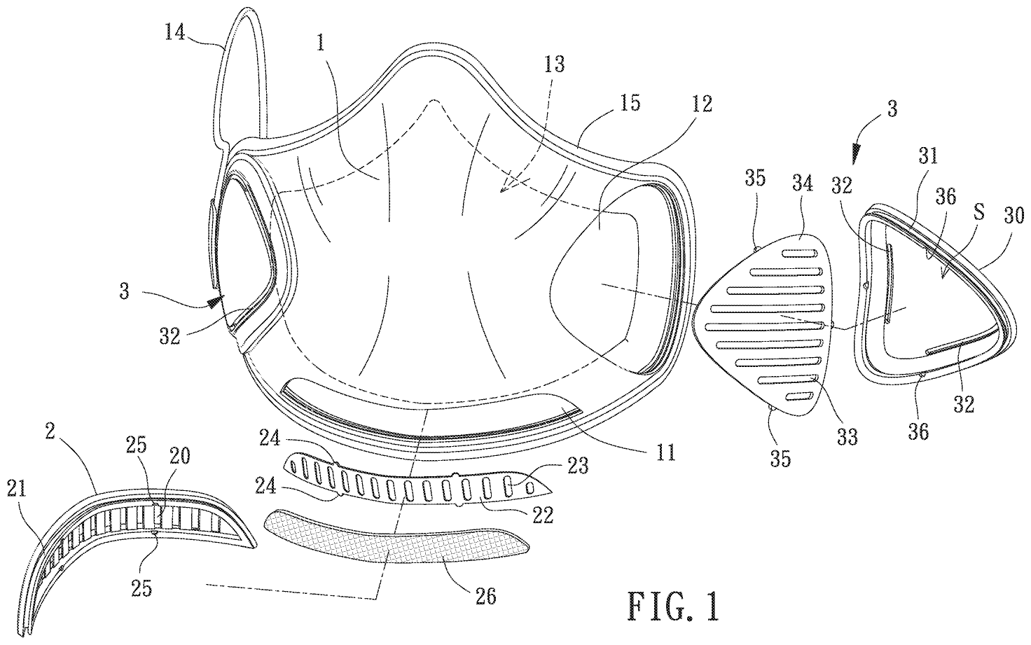

With reference to FIG. 1, a face mask of an embodiment according to the present invention comprises a body 1, a first airflow member 2, and at least one second airflow member 3. The first airflow member 2 and the at least one second airflow member 3 are mounted to the body 1.

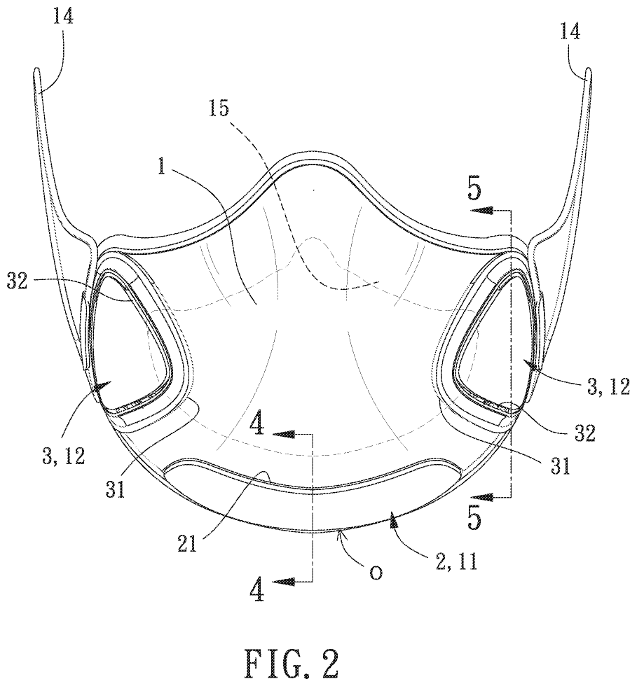

With reference to FIGS. 1 and 2, the body 1 is made of a see-through material, such as transparent synthetic resin (e.g., polyethylene). The body 1 can be transparent or translucent or has a color that can be seen through. The present invention is not limited in this regard. The body 1 is used to cover the nose and mouth of a user. The body 1 can have a shape substantially corresponding to the contour of a human face. For example, the body 1 can include a protrusive intermediate portion adapted to align with the nose of the user and two lateral arcuate extensions for covering the mouth and the cheeks of the user.

The body 1 includes at least one first opening 11 and at least one second opening 12. The number and location of the at least one first opening 11 and at least one second opening 12 are not limited in the present invention. In this embodiment, the body 1 includes a first opening 11 and two second openings 12. The first opening 1 can be adjacent to a lower edge of the body 1 to form a breathing portion. The two second openings 12 can align with the two cheeks of the user, respectively. Preferably, the two second openings 12 are located on two portions of the body 1 most adjacent to two ears of the user, respectively, forming an air inlet portion. An inner side of the body 1 preferably includes an anti-fog layer 13 to prevent loss of the see-through effect resulting from fogging on the inner surface of the body 1 by hot air and water vapor breathed out by the user. The body 1 can further include two connecting members 14 adjacent to the two portions adjacent to the ears of the user. The body 1 can be secured to the face of the user by the two connecting members 14. Preferably, the body 1 includes an annular ring 15 that can be securely disposed on an outer periphery of the body 1 by bonding, coupling, etc., such that better air tightness is provided between the body 1 and the face of the user while providing improved wearing comfort for the user during use.

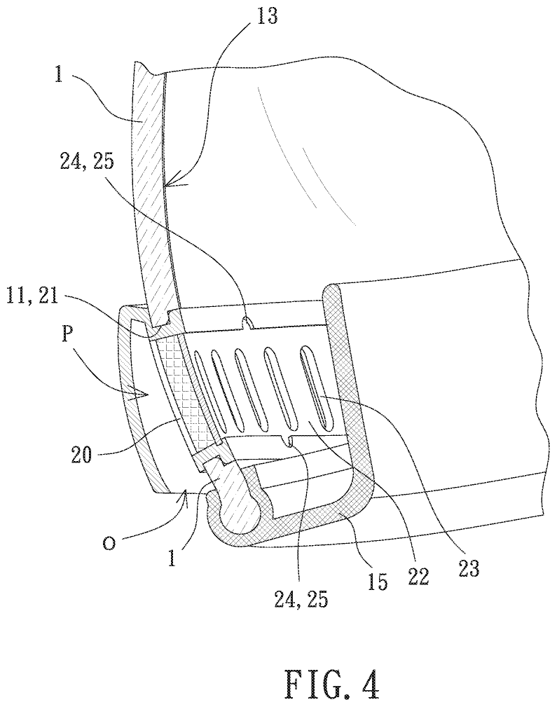

With reference to FIGS. 1 and 4, the first airflow member 2 is coupled to the first opening 11. Preferably, the first airflow member 2 includes a coupling portion 21 on an outer periphery thereof. The coupling portion 21 is preferably annularly disposed on the outer periphery of the first airflow member 2. The first airflow member 2 is coupled to the first opening 11 by the coupling portion 21, such that the first airflow member 2 is detachably coupled to the first opening 11. The first airflow member 2 can include two layers defining a gas passage P therebeween. The inner layer of the first airflow member 2 includes at least one first air hole 20 intercommunicating with the gas passage P, forming an air inlet of the air passage P. Furthermore, the gas passage P has an outlet O at an intersection of the gas passage P and the outside. Preferably, the outlet O faces downwardly. The first airflow member 2 can further include a separation plate 22 on an inner side thereof facing the body 1. The separation plate 22 can be made of a skin-friendly material, such as rubber. Thus, improved comfort is provided when the face of the user contacts with a first face of the separation plate 22. The separation plate 22 preferably has at least one second air hole 23 misaligned from the at least one first air hole 20. Thus, the air entered via the at least one second air hole 23 moves in a non-rectilinear path to the at least one first air hole 20. The first airflow member 2 can further include a filter 26 abutting a second face of the separation plate 22. The filter 26 can be made of melt blown nonwoven fabric, such that the first airflow member 2 can have a better filtering effect. Preferably, the separation plate 22 and the first airflow member 2 are coupled by a plurality of coupling blocks 24 and a plurality of coupling grooves 25, such that the separation plate 22 and a filter 26 are detachably coupled to the first airflow member 2.

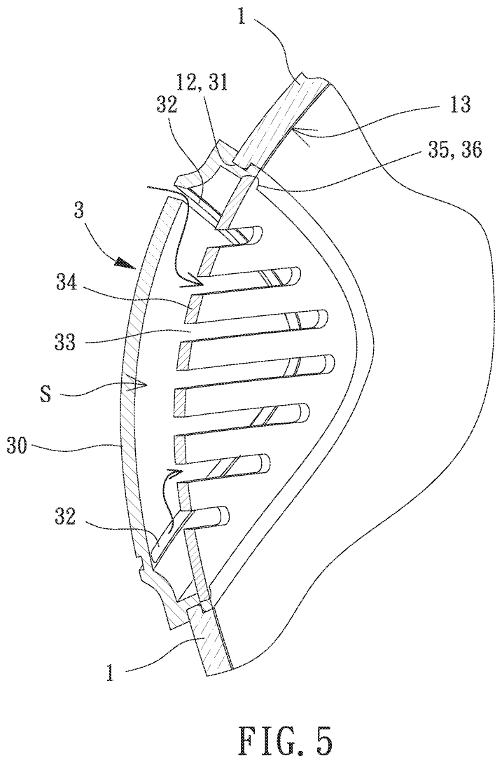

With reference to FIGS. 1 and 5, the second airflow member 3 is coupled to the second opening 12. Preferably, the second airflow member 3 includes a coupling portion 31 on an outer periphery thereof. The coupling portion 31 is preferably annularly disposed on an outer periphery of a lid 30 of the second airflow member 3. The second airflow member 3 is coupled to the second opening 12 by the coupling portion 31, such that the second airflow member 3 is detachably coupled to the second opening 12. The second airflow member 3 includes a chamber S, at least one air inlet 32, and at least one air outlet 33. The at least one air inlet 32 intercommunicates with the outside, such that ambient air can enter the chamber S. The at least one air outlet 33 intercommunicates with an interior of the body 1, such that the air in the chamber S can enter the interior of the body 1 and reach the user. The at least one air outlet 33 is misaligned from the at least one air inlet 32, such that the air entered via the at least one air inlet 32 moves in a non-rectilinear path to the at least one air outlet 33. Preferably, the second airflow member 3 further includes a covering plate 34, and the chamber S is defined between the covering plate 34 and the lid 30 of the second airflow member 3. The at least one air outlet 33 is formed in the covering plate 34. Preferably, the covering plate 34 is detachably coupled to the lid 30 of the second airflow member 3. In this embodiment, the covering plate 34 and the lid 30 of the second airflow member 3 are coupled together by a plurality of coupling blocks 35 and a plurality of coupling grooves 36, such that the covering plate 34 and the lid 30 of the second airflow member 3 are detachably coupled.

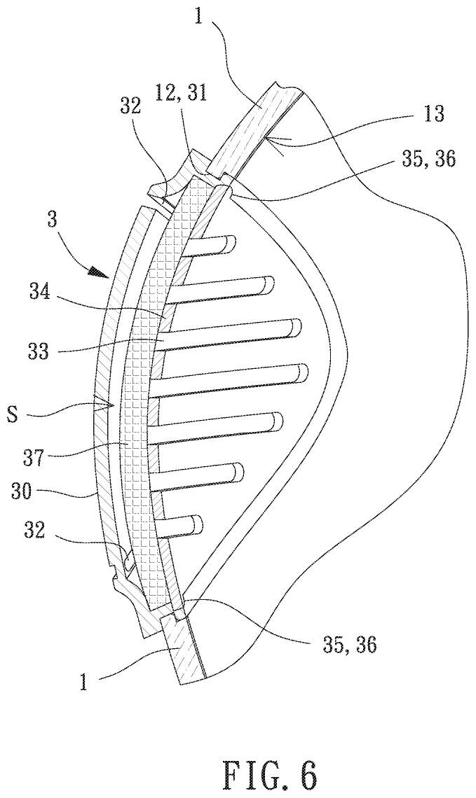

With reference to FIG. 6, a filter 37 is preferably disposed in the chamber S. The filter 37 can be made of melt blown nonwoven fabric. The air entered via the at least one air inlet 32 is filtered by the filter 37 and then enters the interior of the body and reach the user 1 via the at least one air outlet 33.

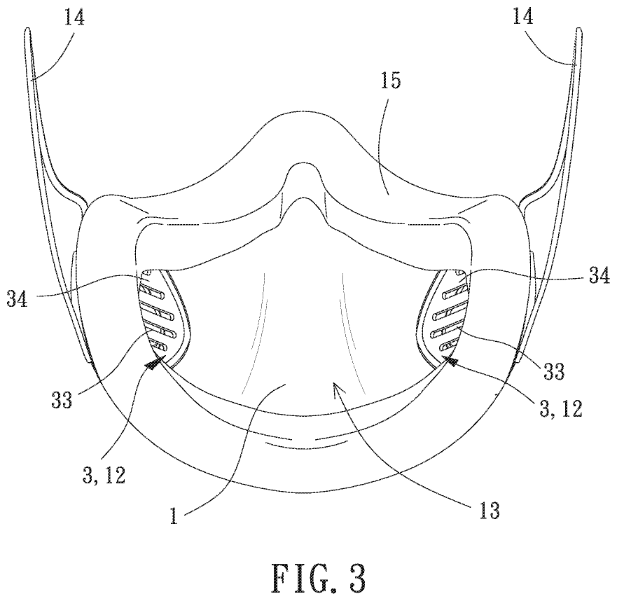

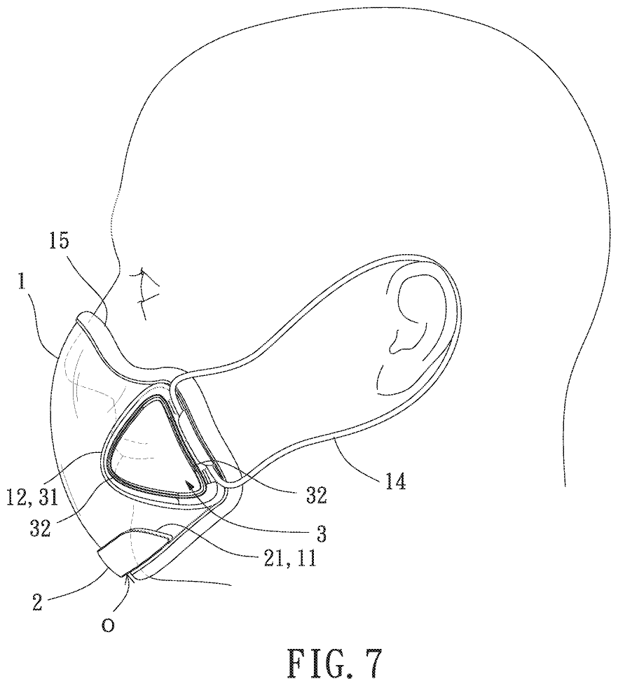

With reference to FIGS. 2, 3, and 7, in use of the face mask according to the present invention, the user can secure the body 1 to his or her face by the two connecting members 14. In the case of the body 1 having an annular ring 15 disposed along the outer periphery thereof, better airtightness is provided between the body 1 and the face of the user to reduce the amount of air leakage via the annular periphery of the body 1 while providing wearing comfort. Thus, the gas breathed out by the user flows through the at least one second air hole 23 and the filter 26 and then flow into the air passage P and exit the outlet O. Since the movement path of the gas is not rectilinear, the gas carrying droplets can collide with the filter 26, preventing the droplets from moving to the outside to thereby stop the droplets. Furthermore, since the gas in the gas passage P can only exit via the outlet O at the lower side thereof, hot air inside the body 1 is prevented from moving upwards, avoiding fogging of the surface of the body 1.

Furthermore, when the user breathes to draw in air, since the at least one air outlet 33 misaligns from the at least one air inlet 32, the air entered via the at least one air inlet 32 moves in a non-rectilinear path. When the air carrying droplets enters the chamber S, the air and droplets can collide with the covering plate 34 and then enter the body 1 via the at least one air outlet 33. Alternatively, the air is filtered and then enters the body 1 before being breathed in by the user, thereby avoiding droplet infection.

It is worth noting that since the first airflow member 2 is detachably coupled to the first opening 11 and the second airflow member 3 is detachably coupled to the second opening 12, the user can periodically replace the filters 26 and 37 according to need, such that the face mask can maintain an excellent filtering effect. Furthermore, proper filters 26 and 37 can be disposed according to user's needs in terms of different grades (medical, industry, or household), permitting flexible adjustment in the filtration grade.

Furthermore, since the face mask according to the present invention has the gas passage P, when the user speaks, the voice of the user can be transmitted to the outside via the at least one second air hole 23 and the gas passage P. Thus, the magnitude of the voice of the user will not drop significantly when transmitted to the outside, effectively maintaining the communication effect.

In view of the foregoing, in the face mask according to the present invention, the body and the face of the user have better airtightness therebetween, reducing air leaking into the body from the annular periphery of the body while providing better wearing comfort. Furthermore, since the body is made of a see-through material, other people can clearly see most portions of the face of the user from the outside. Thus, the user wearing the face mask can still use the facial unlocking function of an electronic product, permit identity confirmation by the face, transmit facial expressions, or permit other people to read his or her lip language without removing the face mask. Furthermore, the separation plate communicates with the gas passage P by the at least one second air hole, the voice of the user can effectively be transmitted, reducing adverse influence on the voice transmission. Furthermore, since the gas moves in a non-rectilinear path, the droplets breathed out by the user can be avoided from moving to the outside via the gas passage P, and droplets in the environment can be avoided from entering the face mask, increasing the protection level. Furthermore, by replacing the filters, the face mask can maintain an excellent filtering effect and can be adjusted according to user needs of different levels. Furthermore, the face mask can be repeatedly used to reduce the economic burden to the user.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A face mask comprising:
a body made of a see-through material and including a first opening and a second opening;
a first airflow member coupled to the first opening, wherein a filter is detachably mounted to the first airflow member and is aligned with the first opening; and
a second airflow member coupled to the second opening, wherein the second airflow member includes a chamber, at least one air inlet, and at least one air outlet, wherein the at least one air inlet intercommunicates with an outside, wherein the at least one air outlet intercommunicates with an interior of the body and is misaligned from the at least one air inlet.

2. The face mask as claimed in claim 1, wherein the first airflow member includes two layers defining a gas passage therebeween, wherein the first airflow member includes at least one first air hole therein, wherein the at least one first air hole intercommunicates with the gas passage, wherein the gas passage has an outlet at an intersection of the gas passage and the outside, and wherein the filter covers the at least one first air hole.

3. The face mask as claimed in claim 2, wherein the first airflow member includes a separation plate having at least one second air hole, and wherein the filter is located between the at least one first air hole and the at least one second air hole.

4. The face mask as claimed in claim 3, wherein the at least one air first hole is misaligned from the at least one second air hole.

5. The face mask as claimed in claim 3, wherein the separation plate and the first airflow member are coupled by at least one coupling block and at least one coupling groove, permitting detachable coupling between the separation plate and the first airflow member.

6. The face mask as claimed in claim 2, wherein the outlet of the gas passage faces downwardly.

7. The face mask as claimed in claim 1, wherein the chamber is defined between a covering plate and a lid of the second airflow member, and wherein the at least one air outlet is formed in the covering plate.

8. The face mask as claimed in claim 7, wherein the chamber receives another filter.

9. The face mask as claimed in claim 1, wherein the body includes an anti-fog layer disposed on an inner surface of the body.

10. The face mask as claimed in claim 1, wherein the body includes an annular ring disposed on an outer periphery of the body.
